(19) United States
(12) Patent Application Publication
(10) Pub. No.: US 2008/0057974 A1
(43) Pub. Date: Mar. 6, 2008

(54) METHOD AND APPARATUS TO FACILITATE RETRIEVING INFORMATION FROM A WIRELESS TWO-WAY COMMUNICATION APPARATUS

(75) Inventor: Jian Liu, NanJing (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/469,970

(22) Filed: Sep. 5, 2006

(51) Int. Cl. H04Q 7/20

(52) U.S. Cl. 455/456.1

(57) ABSTRACT

A user is able to remotely cause their wireless two-way communication apparatus (300) (such as a cellular telephone) to provide information as is stored at the apparatus (such as an answering machine message) to the user to enable the user to cause that information to be played back and hence reviewed and considered. By one approach, a location that is both physically remote from and logically distinct from the wireless two-way communication apparatus (such as, but not limited to, an Internet Service Provider server) receives (101) such a request for information from the user and uses (102) that request to form a corresponding message. The latter can be configured and arranged to cause the receiving wireless two-way communication apparatus to, in turn, responsively forward the requested information. This message can then be forwarded (103) to the wireless two-way communication apparatus.

### TECHNICAL FIELD

This invention relates generally to wireless two-way communication devices and more particularly to the retrieval of information stored in such devices.

### BACKGROUND

Wireless two-way communication apparatuses of various kinds are known in the art. In many cases such devices employ one or more kinds of cellular telephony approaches and techniques to support their wireless functionality. Over time, such devices have become considerably more capable and sophisticated. As but one illustrative example in this regard, many cellular telephones are now capable of acting as an answering machine. So configured, such a device can automatically answer an incoming call and provide an opportunity for the calling party to leave an audio message. The device records the audio message, when offered, and stores that audio message for later playback by that device's user as with an ordinary answering machine.

Unfortunately, at present, such a user must be able to physically access and manipulate their cellular telephone in order to take advantage of such a capability. That is, the user must be locally present with the cellular telephone in order to be able to cause that device to play back a previously stored audio message and to hear that audio message when played back.

Such a limitation can comprise a disincentive to use the feature and can also cause considerable inconvenience and/or confusion for the user. Being physically separated from the cellular telephone will typically mean that the user is without any options regarding obtaining their messages or even determining if any such messages exist to be heard. This, in turn, can lead to lost opportunities, social and/or professional embarrassment, and other related problems and concerns.

### BRIEF DESCRIPTION OF THE DRAWINGS

The above needs are at least partially met through provision of the method and apparatus to facilitate retrieving information from a wireless two-way communication apparatus described in the following detailed description, particularly when studied in conjunction with the drawings, wherein:

FIG. 1 comprises a flow diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a call flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a user is able to remotely cause their wireless two-way communication apparatus (such as a cellular telephone) to provide information as is stored at the apparatus (such as an answering machine message) to the user to enable the user to cause that information to be played back and hence reviewed and considered. By one approach, a location that is both physically remote from and logically distinct from the wireless two-way communication apparatus (such as, but not limited to, an Internet Service Provider server) receives such a request for information from the user and uses that request to form a corresponding message. The latter can be configured and arranged to cause the receiving wireless two-way communication apparatus to, in turn, responsively forward the requested information. This message can then be forwarded to the wireless two-way communication apparatus.

The wireless two-way communication apparatus, upon receiving that message, can then use that wireless message to identify the previously stored information of interest along with, for example, a network address. By one approach, this network address is provided by the user when submitting the previously mentioned request for information and comprises a network address to which the user wishes the requested information to be sent. In response to receiving this message, the two-way wireless communication apparatus can then automatically forward the previously stored information of interest to that network address to thereby make that information presently and locally available to the user.

So configured, a user is readily able to access and instruct their two-way wireless communication device (such as a cellular telephone) via, for example, a personal computer to forward items such as previously recorded answering machine messages to a network address of choice. For example, such information could be forwarded to the same personal computer being used by the user to source the request for information. These capabilities, in turn, effectively permit the user to obtain information stored on their two-way wireless communication devices regardless of the relative physical distance between the user and such devices. Accordingly, such a user is better able to avoid missing important messages and experiencing the corresponding consequences of missing such content.

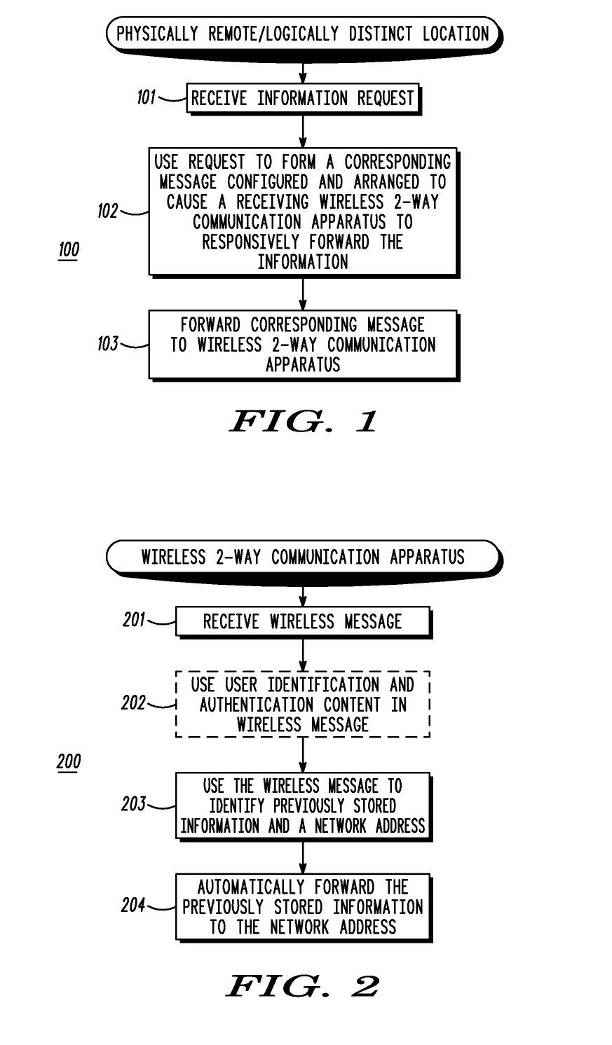

These and other benefits may become clearer upon making a thorough review and study of the following detailed description. Referring now to the drawings, and in particular to FIG. 1, these teachings will readily accommodate a process 100 that may be practiced at a location that is physically remote from and logically distinct from the target wireless two-way communication apparatus. Various platforms are capable of serving in such a role. By one approach, an Internet Service Provider server will provide a ready and useful basis in this regard. Such platforms are well known in the art and are typically at least partially programmable. Such a platform can be readily programmed to operate in accordance with the teachings set forth herein.

Pursuant to this process 100, the latter location/platform receives 101 a request for information that is presently retained or otherwise controlled by a given wireless two-way communication apparatus. This information can comprise, for example, but is certainly not limited to, answering machine content that is stored on the wireless two-way communication apparatus. If desired, this request for information can be sourced by a user via, for example, a personal computer. As but one illustration in this regard, the personal computer and the location/server that receives the request can be coupled via a network such as the Internet. Such a coupling can be facilitated, for example, by use of a browser-based interface as is well known in the art.

By one approach, this request for information includes, at least in part, a user identifier as well as corresponding authentication content. The user identifier can be specific to the user and/or to the user's target platform to which the request for information is ultimately intended. Any identifier(s) of choice can be employed in this regard including but not limited to alphabetic strings (such as proper names), numeric strings (such as addresses, aliases, or the like), alphanumeric strings (such as addresses and the like), or even biometric information as corresponds to the user (such as asperity information such as fingerprints, palm prints, or the like).

Similarly, the authentication content can comprise any content of choice in this regard. By one approach this authentication content can comprise a shared secret such as, but not limited to, a password. There are many ways by which such identifiers and authentication content can be generated, selected, chosen and so forth. As these teachings are relatively insensitive to the selection and use of any particular choice in this regard, for the sake of brevity further elaboration regarding such matters will not be presented here.

This process 100 then provides for using 102 this request to form a corresponding message that is to be forwarded to and received by the target wireless two-way communication apparatus. By one approach this message can comprise a Short Message Service (SMS) message which message format is well understood in the art. Such a message format is readily propagated through the Internet and will further be readily compatibly received and processed by a number of existing wireless two-way communication apparatuses. Other formats and styles of message, of course, could be employed as appropriate to suit the needs and/or opportunities as correspond to a given application setting.

In general, this message is configured and arranged to cause the receiving wireless two-way communication apparatus to responsively forward the requested information in a particular manner. This can comprise, for example, a particular control/operational code, expression, or instruction having this particular meaning. The specific form of this control/operational code can vary greatly with the specific limitations and/or opportunities as characterize a given message protocol and syntax of choice.

This message can also comprise the aforementioned identifier and/or authentication content if desired. It is also possible for this message to further comprise the aforementioned network address. Such supplemental information can be provided in a corresponding block or frame of data or can be presented in one or more message fields that are intended to serve such a purpose. Details regarding such configuration alternatives and opportunities are well known in the art and require no further elaboration in this description.

This process 100 then provides for having this location/platform forward 103 this message to the wireless two-way communication apparatus to facilitate reception and processing of the message. Again, if desired, this can comprise forwarding the message as a Short Message Service message that is ultimately delivered via a wireless network, such as a cellular telephone network, to the target wireless two-way communication apparatus.

Referring now to FIG. 2, the aforementioned wireless two-way communication apparatus (which may comprise, though is not limited to, a cellular telephone) can support a process 200 whereby the wireless two-way communication apparatus wirelessly receives 201 this message. As noted, this can comprise receiving a Short Message Service message containing both operational content to cause the retrieval and forwarding of the information of interest as well as, if desired, user-related information.

This user-related information can comprise the identifier and authentication content noted above if desired. When present (and particularly when required), the wireless two-way communication apparatus can use 202 this user identifier and/or corresponding authentication content to facilitate the process of automatically forwarding the previously stored information as per these teachings. This can comprise, for example, comparing the received user-related information against previously stored trusted content with subsequent actions depending upon the similarity or differences between such items.

In any event, the wireless two-way communication apparatus can then use 203 the wireless message to identify the previously stored information and the provided network address. There are various ways, and degrees of specificity, by which the previously stored information can be so identified. By one approach, if desired, a relatively simple command, instruction, or request can serve as a request that all previously stored information of whatever kind be provided in response to the request. By another approach, a given command, instruction, or request can serve as a request that all previously stored information of a particular kind (such as all answering machine messages) be provided in response to the request. By yet another approach, a given command, instruction, or request can serve as a request that only particular previously stored information items be provided. These can be identified or delineated in any of a variety of ways. For example, specific items can be identified by a specific file name or other similar identifier, by a date and/or time of creation, by a read status, by a file type, and so forth.

The network address can comprise, by one approach, an email address. This email address can comprise, for example, the email account to which the user wishes the previously stored information to be sent. These teachings will accommodate, if desired, having the network address comprise a default or pre-programmed value that is used by the aforementioned server and/or the wireless two-way communication apparatus whenever responding to such a response. These teachings will also accommodate, if desired, using more than one network address, such that retrieved information can be automatically forwarded to more than one destination in response to receiving such a request.

This process 200 then provides for automatically forwarding 204 the identified previously stored information to the aforementioned network address. This action occurs, of course, as a response to reception of the aforementioned wireless message and its contents. When the network address comprises an email address, this action can comprise, for example, forming an email that is addressed to the email address and attaching the previously stored information to the email.

Some email systems impose limitations with respect to the size of attachments that will be permitted. If desired, these teachings will accommodate parsing a total aggregated quantity of information amongst a plurality of similarly addressed emails in order to reduce the size of the attachment for any given one of the email messages.

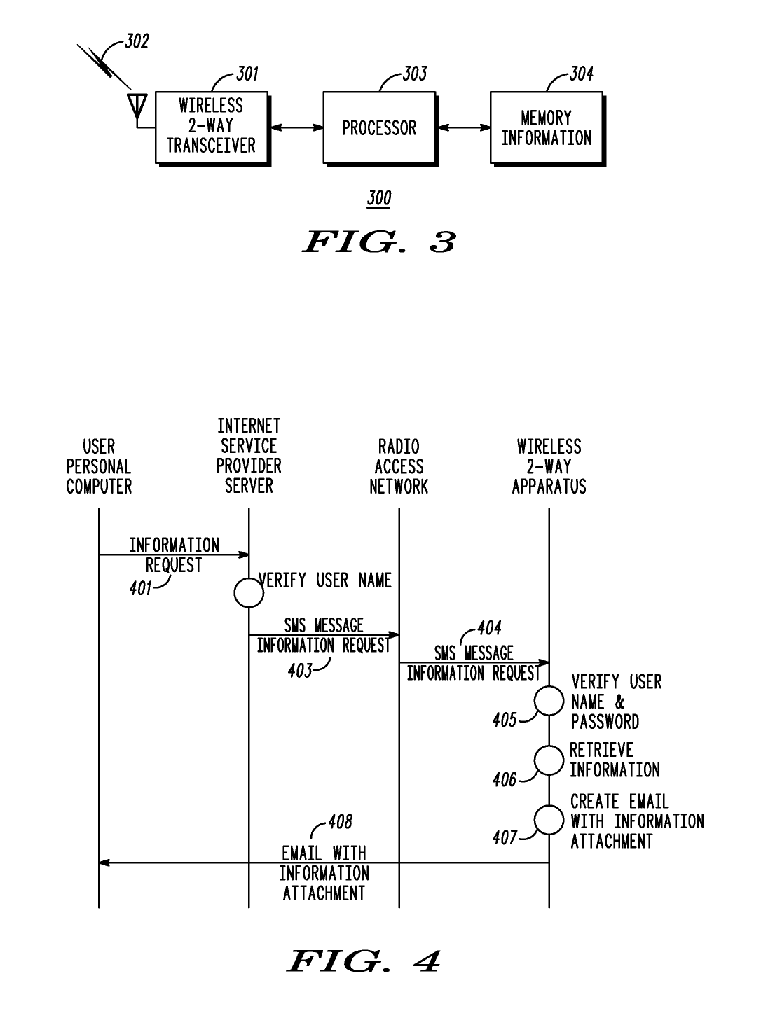

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative example, the platform comprises a cellular telephone 300 having a wireless two-way transceiver 301 of choice that serves to transmit and receive wireless signals 302 that comprise the messages described above. For example, this can comprise a wireless signal 302 that constitutes a Short Message Service message as well as an email message, both as are detailed herein. Various wireless technologies can be employed in conjunction with these teachings. As such technologies are well understood in the art, for the sake of brevity further description in this regard will not be presented here.

This wireless two-way transceiver 301 operably couples to a processor 303 which in turn couples to a memory 304. By one approach this memory 304 has information stored therein. This can comprise, for example, the aforementioned previously stored information such as, but not limited to, audio content such as answering machine messages.

The processor 303 can comprise, for example, a partially or wholly programmable platform. This, in turn, will readily permit programming the processor 303 to carry out selected teachings as are set forth herein. For example, this processor 303 can be configured and arranged (via, for example, appropriate programming) to use a received wireless message to identify previously stored information that is stored in the memory 304 along with a network address and to then automatically forward that previously stored information to that network address.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

Referring now to FIG. 4, an illustrative example will now be offered by way of further explanation. Those skilled in the art will recognize and understand that the specifics of this example serve an illustrative purpose only and are not intended to represent specific points of limitation or lack of alternatives.

In this example, a user uses a personal computer to source an information request 401 (via, for example, the Internet) to an Internet Service Provider (ISP) server. The latter then verifies 402 a user name and password as is contained in the information request 401 and forwards a corresponding Short Message Service message that comprises an information request 403 and 404 to an identified target wireless two-way communication apparatus via an intervening radio access network as is known in the art.

Once received at the wireless two-way communication apparatus, in this example the latter verifies 405 the user name and password and then retrieves 406 the corresponding information for its native stores. The wireless two-way communication apparatus then creates 407 an email message having such information appended as an attachment and transmits that email with its information attachment 408.

So configured, a user can readily and reliably cause a remotely located wireless two-way communication apparatus such as a cellular telephone to respond with the provision of any of a variety of previously stored content to a given network address. This could even comprise, for example, transmitting such content to yet another cellular telephone if so desired. Those skilled in the art will appreciate that these benefits are attainable with only modest changes to the functionality of the infrastructure and wireless two-way communication apparatus and in a manner that readily leverages existing messaging and signaling protocols.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A method for use in retrieving information from a wireless two-way communication apparatus, comprising:
at a location that is both physically remote from and logically distinct from the wireless two-way communication apparatus:
receiving a request for the information;
using the request to form a corresponding message, which message is configured and arranged to cause a receiving wireless two-way communication apparatus to responsively forward the information;
forwarding the corresponding message to the wireless two-way communication apparatus.

2. The method of claim 1 wherein the location comprises, at least in part, an Information Service Provider (ISP) server.

3. The method of claim 1 wherein the information comprises answering machine content that is stored on the wireless two-way communication apparatus.

4. The method of claim 1 wherein the request comprises, at least in part, a user identifier and corresponding authentication content.

5. The method of claim 4 wherein the authentication content comprises a password.

6. The method of claim 1 wherein the message comprises a Short Message Service (SMS) message.

7. The method of claim 1 wherein the message comprises, at least in part, a network address to which the two-way wireless communication apparatus should forward the information.

8. The method of claim 7 wherein the network address comprises an email address.

9. A method for use in forwarding previously stored information from a wireless two-way communication apparatus, comprising:
at the wireless two-way communication apparatus:
receiving a wireless message;
using the wireless message to identify the previously stored information and a network address;
in response to receiving the wireless message, automatically forwarding the previously stored information to the network address.

10. The method of claim 9 wherein the wireless two-way communication apparatus comprises a cellular telephone.

11. The method of claim 9 wherein the wireless message comprises a Short Message Service (SMS) message.

12. The method of claim 9 wherein the wireless message comprises, at least in part, a user identifier and corresponding authentication content.

13. The method of claim 12 further comprising:
using the user identifier and corresponding authentication content to facilitate automatically forwarding the previously stored information to the network address.

14. The method of claim 9 wherein the network address comprises an email address.

15. The method of claim 14 wherein automatically forwarding the previously stored information to the network address comprises forming an email that is addressed to the email address and attaching the previously stored information to the email.

16. An apparatus comprising:
a wireless two-way transceiver;
a memory having information stored therein;
a processor that is operably coupled to the wireless two-way transceiver and the memory and that is configured and arranged to:
use a received wireless message to identify previously stored information that is stored in the memory and a network address;
automatically forward the previously stored information to the network address.

17. The apparatus of claim 16 wherein the apparatus comprises a cellular telephone.

18. The apparatus of claim 16 wherein the information comprises, at least in part, audio content.

19. The apparatus of claim 16 wherein the received wireless message comprises a Short Message Service (SMS) message.

20. The apparatus of claim 16 wherein the process is further configured and arranged to automatically forward the previously stored information to the network address as an email attachment.
